(19) United States
(12) Patent Application Publication
(10) Pub. No.: US 2008/0263493 A1
(43) Pub. Date: Oct. 23, 2008

(54) Method and Apparatus for Tie Net Routing

(75) Inventors: Christopher J Berry, Hudson, NY (US); Alan Wagstaff, Hyde Park, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/737,280

(22) Filed: Apr. 19, 2007

(51) Int. Cl. G06F 17/50

(52) U.S. Cl. 716/12

(57) ABSTRACT

A method of performing tie net routing within an integrated circuit chip is disclosed without using wiring. Due to repeated use of designs in modern chip, there are often unused portions of the design that need to be connected permanently to a local logical1 or logical 0. These connections, known as tie nets, are not timing critical signals that, when poorly implemented can get in the way of functional signals in an integrated circuit. The current method is to connect the pin to the nearest power connections of the correct polarity. This requires some amount of wiring resources that may be needed for other functions or pin access. Accordingly, the present invention avoids this situation by avoiding wiring.

### FIELD OF THE INVENTION

The present invention relates to integrated circuit designs in general, and, in particular. In an integrated circuit (IC) having physical hierarchy. Still mere particularly, the present invention relates to a method for net routing within an IC chip using no wiring tracks.

### DESCRIPTION OF BACKGROUND

Physical hierarchy is one way for integrated circuit's to be designed by many people concurrently. An example design may have 3 levels of hierarchy. The first level of hierarchy would be the gates (nand's, nor's, etc). The second level of hierarchy would be the macro. A macro would contain functional groups of nand's and nor's and there may be hundreds of macros on a chip. The third level of hierarchy would be the chip. On the chip could be gates and macros, or just macros. In designing an integrated circuit in this way a gate or macro can be designed once and used many times. They can also be designed concurrently with other levels of hierarchy to reduce overall design time for the IC. For them to be designed concurrently a contract must be decided upon between the two levels of hierarchy. This contract encompasses the places where the input and output connections are to be placed and of what size and shape those connections will be. These are referred to as the child's pins and represents the location that the child and parent will both deliver or receive their shared signals. Also represented in the contract is the silicon and wiring resources that the child is allowed to use and the parent is not allowed to use.

In many cases when designing an IC there is a need to set the input value of a gate to either a logical 0 or 1. This is done by connecting the input of that gate to either the ground supply or the power supply. That connection is referred to as a tie net. In fact any logical connection to the power grid is called a tie net. You may wonder why there are tie nets at all. A designer sometimes requires a logical 1, why don't you change the logical description so that the logical 1 is not needed at all. The reason that tie net's ere needed is because of design reuse. For reasons that don't need to he described here there is generally a lot of design reuse on an integrated circuit and across multiple integrated circuits. However, one usage of a design may need to default a value to a 1 and another usage of the same design may need to default a value to a 0. A simple example would be a logical block that is used twice in a chip. Each usage of the block needs to know which instantiation it is (as it's function is affected). This block would therefore have a block_id input that could be set to either a 0 or a 1 by the instantiating design (the parent).

The current trend in IC design work is to increase the use of numerous special purpose or standard macros and other devices that have multiple applications. This increases the complexity of the design and can create the need for multiple levels of hierarchy and abstraction. Abstraction in and of itself can get in the way of making tie net connections, which is why this method is predicated on the use of abstraction. It is intended to help avoid some of the pitfalls with tie net routing that abstraction and hierarchy can create. It is also based on the fact that ICs may use multiple voltage levels in various isolated areas of the design, such as power islands, which can complicate the design process and which require a regular power grid throughout the design.

The current method of tie net routing is to make a connection from the physical pin on the child that needs to get tied to the proper polarity power rail in the parent. This method inherently uses the parent's wiring resources to make these connections. These resources may be better used making functional connections. In general the wiring resources used are pretty minimal so it's not normally of greet concern, but there are always cases where the tie connections occur in congested areas and add to the congestion of the parent. There are also times when there are lots of tie connections in a given area and they create their own congestion and make it difficult for each other to route. The basic idea is that because of the abstraction needed for the hierarchical design style the tie net connections need to be made at the next level of hierarchy (or parent). Which, using our previous three levels of hierarchy example, that tie connections that a macro needs must be made inside of the chip.

### SUMMARY OF THE INVENTION

The shortcomings of the prior art are overcome and additional advantages are provided through the provision of taking advantage of the tie net routing method of the present invention without wiring. It is that tie nets are connections into globally distributed power signals of which there are enormous numbers of physical shapes that are all logically (and electrically) equivalent These signals have shapes in all levels of hierarchy and occur regularly and frequently. Because of this it is very likely that signals inside of a macro have shapes that cross each of the different power signals. Which means that macro signals that need to get tied in the chip most likely already cross a physical shape in the macros hierarchy that is of the polarity that the tie connection requires. The essence of the present invention is to ignore the physical hierarchy and to create a connection between the macro's internal wire and a power rail of the proper polarity by instantiating a simple via between the two crossing shapes. Logically and electrically this is similar to how it is currently done. The tie net is created between the macro's pin and the power or ground signal that is required. An additional advantage is to allow proximity of the connection between the power grid and the signal net. This is very useful to prevent power island problems during manufacturing, of which a description is beyond the scope of this document. Physically it is different in that the connection is made in an area of the macro that the parent is not supposed to be using to make parent level connections. This is a violation of the basic principle described earlier and cannot be done while both the macro and chip are still in flux. The macro should be stable and unchanging for the chip to take advantage of this. Otherwise the solution the chip comes up with may not apply after the macro changes.

System and computer program products corresponding to the above-summarized methods are also described and claimed herein.

Additional features and advantages are realised through the techniques of the present invention. Other embodiments and aspects of the invention are described in detail herein and are considered a part of the claimed invention. For a better understanding of the invention with advantages and features, refer to the description and to the drawings. . . .

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a high-level flow logic diagram of a method for tie net routing using no wiring tracks in accordance with the present invention; and

FIG. 2 is a schematic diagram comparison of the conventional method of the conventional tie net routing using wiring on the top portion of the FIG. 2 with the method of tie net routing without wiring in accordance with the present invention on the bottom portion of FIG. 2.

The detailed description explains the preferred embodiments of the invention, together with advantages and features, by way of example with reference to the drawings.

### DETAILED DESCRIPTION OF THE INVENTION

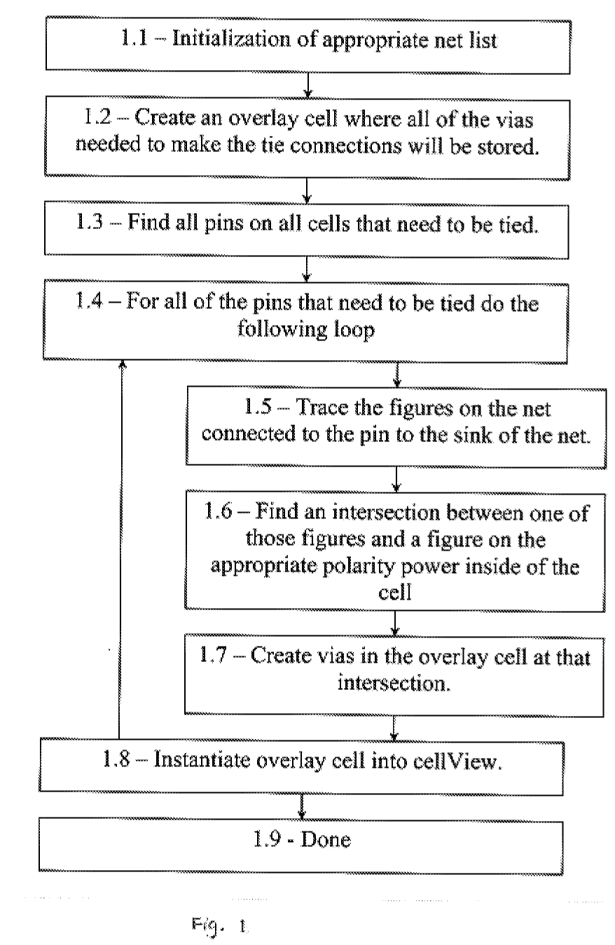

Turning now to the drawings in greater detail, it will be seen that in FIG. 1 there is depicted a high-level logic flow diagram of a method of tie net routing without wiring in accordance with the present invention. Basically the method is a router which finds the pins requiring connections to global nets from a nearly completed level of hierarchy, like power or ground, and traces their connection to the child. The trace attempts to find the connections to the gate an the input transistor terminals. Once the trace is completed, the path is followed backwards looking for the desired global infrastructure net one layer below or above the current route. Once the intersection has been found, the largest legal via that can fit in the overlap space is placed on top of the child. This via connects the child route to the child's global infrastructure net, completing the route.

The first step in the process is to initialize the system is performed, as shown in block 1.1. A netlist is used to identify which nets are tie nets and which are not in the design that this is being run. After identifying the nets, it is confirmed that there are cells instantiated in the design that need to be tied. Then it is determined that the cells instantiated have power grids with the same polarities as are needed for tie routing. Finally, a complete check is done to ensure the cells instantiated either are layouts (complete designs) as opposed to abstracts (a simpler abstracted representation) or have layouts that can be found somewhere in the design management system.

Accordingly, the initialisation step determines if all the prerequisites are met in which case the process will be initiated.

The first step of the process shown in block 12 is to create a cellview that can be created and instantiated into the design. This cellview is where all of the vias (shapes that connect one metal layer to another metal layer in the design) that will create the logical connections to the power grid metal layer will be created as a tie net. Once the process is completed this cellview is instantiated into the design and the connections will be made.

The second step shown in block 1.3 is for the process to identify all of the pins on all of the macros that need to be tied. This will be different depending on methodologies, and technologies being used. For example, pins on each macro that are part of the power grid distribution do not need to be tied since they are inherently connected to the power grid because they already are part of the power grid distribution. There are also pins that have logical functionality on macros that do need to be tied. These pins can be differentiated from the pins that connect to the power grid either using the logical name of the pin, or the logical function of the pin. The list of identified pins is passed onto the next part of the process.

The third part of the process as shown in block 1.4 is for the program to iterate through each pin in the list of identified pins from the previous step. For each of the pins that need to be processed the method has the following steps:
1. Find the physical shape that represents the pin in the macro layout in block 1.4;
2. Then electrically trace from that physical shape to the other end of the macro's internal net as shown in block 1.5;
3. Identify the first intersection along those traced shapes of another shape on either metal layer N+1 or N−1 (one layer above or one layer below respectively) as shown in block 1.6; and
4. Create a via in the overlay cell that makes a connection between the traced shape and the intersected shape as shown in 1.7

Finally, the fourth part of the process as shown in block 1.8 is to save the cellview created in the first step and instantiate it into the design.

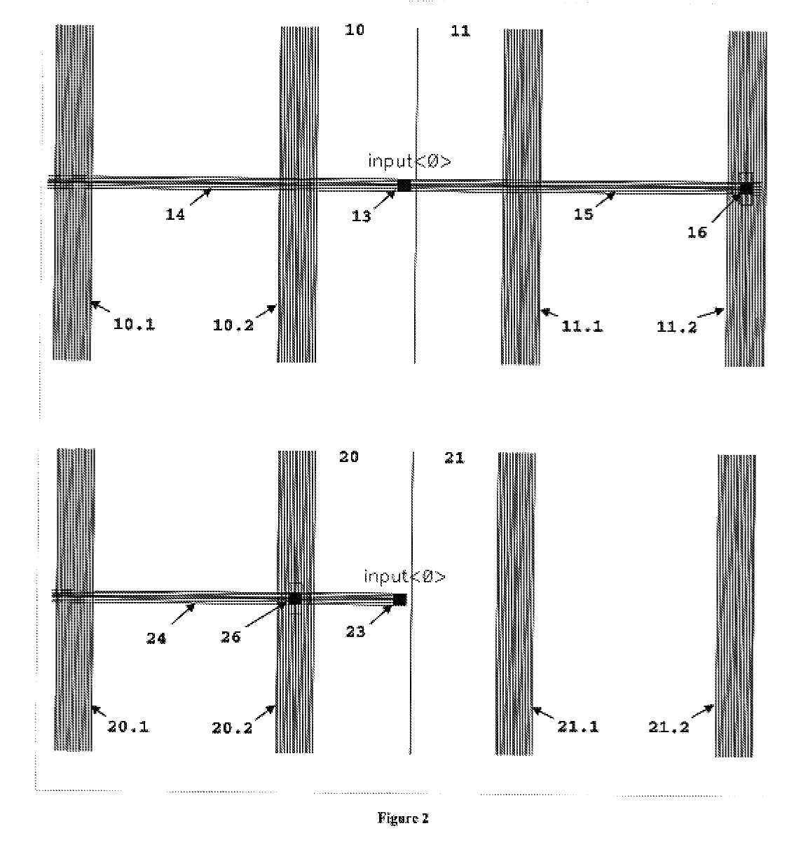

Attention is now directed to FIG. 2 which illustrates the results the results of the process of the present invention as compared to the method used in the prior art. The top right and left top portion of FIG. 2 represents a macro side of the hierarchy (child side) 10 and the chip side of hierarchy (parent side) 11 respectively of the conventional tie routing using wiring. Likewise the right and left lower portion of FIG. 2 represents the results of the macro side of hierarchy (child side) 20 and the chip side hierarchy 21 of the method in accordance with the present invention for tie routing without wiring. The macro side 10 and 20 represent the child owned area as previously discussed. The chip side hierarchy 11 and 21 represent the parent owned area as previously discussed. The vertical lines in both areas are wires that represent the power grid in the parent area (chip side) 10.1, 10.2, 11.1, 11.2, 20.1, 20.2, 21.1, and 21.2, and the child area (macro side). In the top portion, a central pin 13 (<0>) interconnects the internal wiring 14 used for tie connections from the child side of the macro 10 to the external wiring 15 and tie connections with the power rails of the parent side of the chip 11. This external wiring 15 is then connected to the power rail at 11.2 on power rail 12 which is outside of the chip side hierarchy. In the lower portion, the internal wiring 24 used for tie connections of the child side macro 25 is connected and terminates at pin 23 (<1>). As should now be understood the parent owned chip side 21 power rails are not connected. The tie connections are made in the child owned area internally at 26 to power rail 20.2. No extra wiring resources are used or required or used to make tie connections using the present invention.

It should be recognised by one skilled in the art that this process violates the conventional premise of hierarchy design rules. This is due to the top level design is now creating shapes that potentially fall under the ownership of the children cells. Which means that if the children cells change after this process has been run, accordingly, this process must be repeated or problems can occur. That is why this process should only occur after the lower level cells have stabilized and are no longer in danger of changing.

One aspect of the method of the present invention will be to create IC chips having better performance in smaller more reliable packages. These IC chips are more dependable and less expensive to manufacture.

Other aspects of the method of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present Invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of a tie net routing for an integrated circuit (IC) having a plurality of metal layers with at least one layer of physical hierarchy comprising the steps of:
creating a net list overlay cell view having all macros and pins;
selecting all pins in the macros that are required to have a logical connection to the metal layer having a power grid above or below the macro;
identifying an intersection on the power grid above or below the macro; and
creating a via in the cell view that will make the connection between the selected pins and the power grid to complete the tie net.

2. The method of claim 1 wherein the cell view includes all shapes that connect one metal layer to another metal layer in the IC.

3. The method of claim 1 which includes the step of determining which pins that do not need a tie net.

4. The method of claim 3 wherein the determination is based in part by using a logical name of each the pin or the function of each pin.

5. The method of claim 1 that includes the step of finding a physical shape that represents each pin in the macro.

6. The method of claim 1 that includes the step of electrically tracing from the physical shape to an end of the macro internal net.

7. The method of 1 wherein the cell view includes all shapes that connect one metal layer to another metal layer in the IC, and includes the steps of determining which pins that do not need a tie net, finding a physical shape that represents each pin in the macro, and electrically tracing from the physical shape to an end of the macro internal net.

8. The method of claim 1 wherein the cell view includes all shapes that connect one metal layer to another metal layer in the IC, and includes the steps of determining which pins that do not need a tie net, finding a physical shape that represents each pin in the macro

9. The method of 1 wherein the cell view includes all shapes that connect one metal layer to another metal layer in the IC, and includes the steps determining which pins that do not need a tie net by using in part by using a logical name of each the pin or the function of each pin, finding a physical shape that represents each pin in the macro and electrically tracing from the physical shape to an end of the macro internal net.

10. A semiconductor integrated chip (IC) having a plurality of metal layers and at least one layer of physical hierarchy comprising:
a plurality of macros having pins;
means to select the pins that are required to have a logical connection to a power grid on one of the metal layers; and
a plurality of vias positioned through the macro connecting the selected pins to the power grid above or below the macro without wiring.

11. The IC of claim 10 wherein the selected pins may be differentiated by using the logical name of the pin or logical function of the pin.

12. The IC of claim 11 wherein the pins not selected is already part of the power grid or has logical functionality on the macro.

13. The IC of claim 10 which includes means to electrically trace the selected pin to an end of the macro internal net.

14. The IC of claim 10 which includes means to identify a first intersection between the selected pin and the power grid.

15. The IC of claim 10 wherein the selected pins may be differentiated by using the logical name of the pin or logical function of the pin because the pins not selected are already part of the power grid or have logical functionality on the macro and means for electrically tracing the selected pin to an end of the macro internal net.

16. The IC of claim 10 wherein the selected pins may be differentiated by using the logical name of the pin or logical function of the pin because the pins not selected are already part of the power grid or have logical functionality on the macro, and includes means for electrically tracing the selected pin to an end of the macro internal net, and means for identifying a first intersection between the selected pin and the power grid.

17. A computer program residing in a computer storage medium for performing tie net routing within an integrated circuit chip (IC), said program comprising:
program means for creating a net list overlay cell view having all macros and pins;
program means for selecting all pins in the macros that are required to have a logical connection to the metal layer having a power grid above or below the macro;
program means for identifying an intersection on the power grid above or below the macro; and
program means for creating a via in the cell view that will make the connection between the selected pins and the power grid to complete the tie net.

18. The computer program product of claim 17 wherein said computer program product further includes program code means for determining which pins that do not need a tie net.

19. The computer program product of claim 17 wherein said computer program product further includes program cods means for finding a physical shape that represents each pin in the macro.

20. The computer program product of claim 17 wherein said computer program product further includes program code means for electrically tracing from the physical shape to an end of the macro internal net.
